(19) United States
(12) Patent Application Publication
(10) Pub. No.: US 2008/0301225 A1
(43) Pub. Date: Dec. 4, 2008

(54) INFORMATION PROCESSING APPARATUS AND INFORMATION PROCESSING SYSTEM

(75) Inventor: Koichiro Kamura, Fujisawa-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/129,576

(22) Filed: May 29, 2008

(30) Foreign Application Priority Data
May 31, 2007 (JP) 2007-145353

(51) Int. Cl. G06F 15/16

(52) U.S. Cl. 709/203

(57) ABSTRACT

According to one embodiment, an information processing apparatus where a first software including a first operating system and a first program group running on the first operating system, and a second software including a second operating system and a second program group running on the second operating system run concurrently, comprises a client software which belongs to the first program group, and transmits and receives a server software executed by a server connected via a network and data according to a first protocol for performing communication for performing a processing including authentication processing, an access preventing section configure to prevent accessing from the first software to a resource in the second software, and a flowing preventing section configure to prevent information of a plain text regarding the authentication processing from being flowed in the network.

### CROSS-REFERENCE TO RELATED APPLICATIONS

This application is based upon and claims the benefit of priority from Japanese Patent Application No. 2007-145353, filed May 31, 2007, the entire contents of which are incorporated herein by reference.

### BACKGROUND

1. Field

One embodiment of the invention relates to information processing apparatus and information processing system which has client software for performing communication with a server according to a predetermined protocol.

2. Description of the Related Art

With advances in information and communication technology (ICT), solutions of various client-server types have been developed and utilized in various fields. The client-server type solution executes various applications through communication of a client terminal as a personal computer with various servers to read information from the servers or transmit information to the servers, and a procedure or a rule for transmission/reception of information between a client and a server is called a protocol.

New various client-server type protocols are developed and standardization thereof is advanced, while damages such as computer virus infection or worm due to a specification of a client-server type protocol or vulnerability thereof on mounting or information leakage accidents increased rapidly. Therefore, the following matters are repeated.

1. A new protocol is developed

2. Attack on the new protocol is developed by a person with bad intention.

3. Countermeasure to the attack is proposed.

International Publication 00/65456 Pamphlet discloses such a technique that a virtual mail server is provided in a client network and data communication is performed securely by encrypting/decoding data by the virtual mail server using all-purpose electronic mail software.

By utilizing the abovementioned technique, when access is performed by a mail server on Internet from a client network via a virtual server, communication can be securely performed without leakage of information of plain text regarding an authentication processing. However, this technique cannot prevent information of plain text from leaking to a network between a client and the virtual server.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing a schematic configuration of information processing system according to a first embodiment;

FIG. 2 is an exemplary block diagram showing a schematic configuration of a modification example of the information processing system shown in FIG. 1;

FIG. 3 is an exemplary block diagram showing a schematic configuration of information processing system according to a second embodiment; and

FIG. 4 is an exemplary block diagram showing a schematic configuration of a modification example of the information processing system shown in FIG. 3.

### DETAILED DESCRIPTION

Various embodiments according to the invention will be described hereinafter with reference to the accompanying drawings. In general, according to one embodiment of the invention, an information processing apparatus where a first software including a first operating system and a first program group running on the first operating system, and a second software including a second operating system and a second program group running on the second operating system run concurrently, comprises a client software which belongs to the first program group, and transmits and receives a server software executed by a server connected via a network and data according to a first protocol for performing communication for performing a processing including authentication processing, an access preventing section configure to prevent accessing from the first software to a resource in the second software, and a flowing preventing section configure to prevent information of a plain text regarding the authentication processing from being flowed in the network.

### First Embodiment

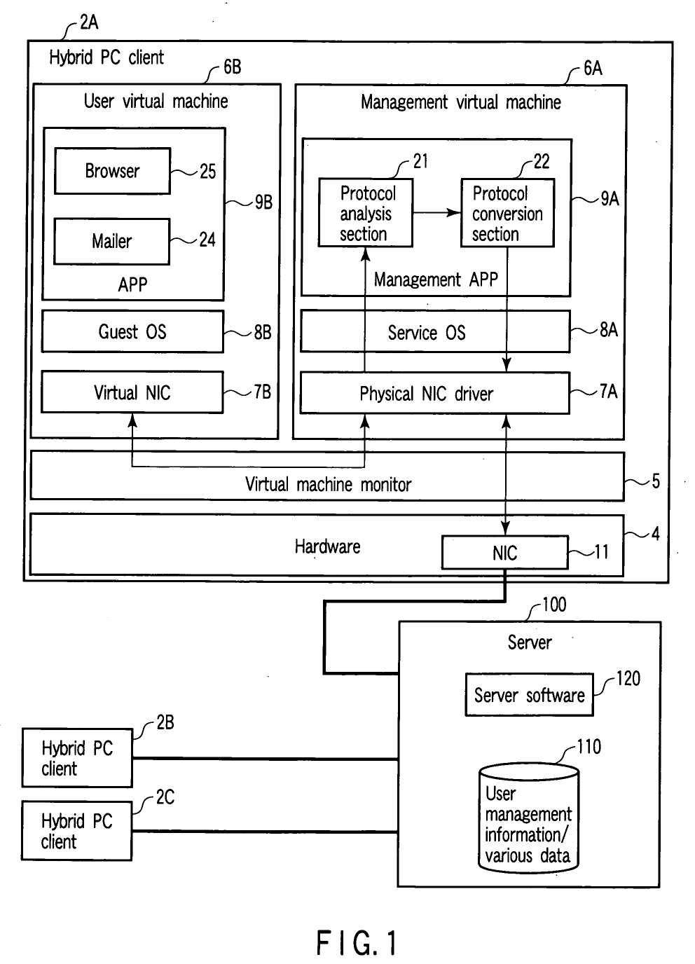

FIG. 1 shows a configuration of information processing system according to an embodiment of the present invention. As shown in FIG. 1, a plurality of hybrid PC clients 2A to 2C and a server 100 are connected to a network such as an office LAN.

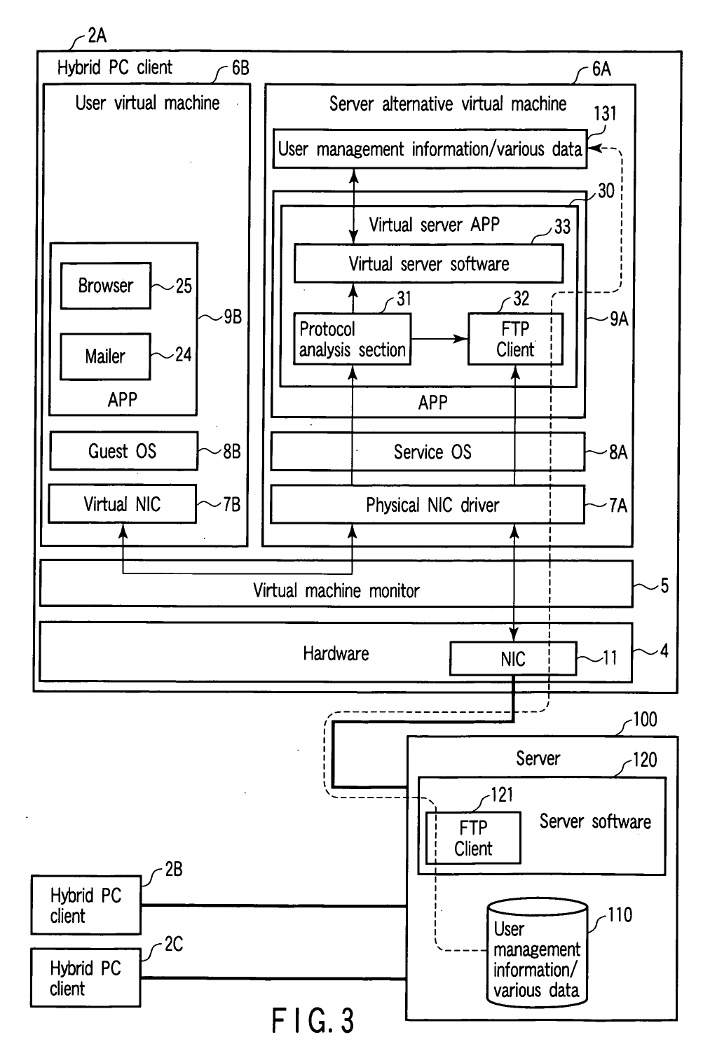

As shown in FIG. 3, the server 100 includes a user management information/various data file 110, and a server software 120.

The user management information/various data file (hereinafter, called a “file”) 110 is a file for user management information such as a user name or a password, data of an electronic mail, or the like. The server software 120 performs communication with applications within a gust OS 8B and a client software 9B in a user virtual machine 6B by using the user management information/various data file to perform a predetermined processing. For example, the server software 120 includes an FTP sever, a mail server, an HTTP server, and the like.

For example, the hybrid PC client 2A comprises a plurality of virtual machines (sub-software resources) obtained by dividing a software resource running in one computer into two groups of a management virtual machine 6A and the user virtual machine 6B, a virtual machine monitor 5 which conducts arbitration such that various client software on the user virtual machine and various virtual server software on the hybrid PC client are isolated from one another on one hardware 2 and they run concurrently, a hardware 4, and the like.

The user virtual machine 6B includes a virtual network interface card (NIC), an operating system (guest OS) 8B used by a user, such as Windows XP, and client software 9B such as a business software, a mailer 24, and a browser 25.

At least one of the client software 9B is to use a protocol which does not encrypt data, such as transmitting authentication information in a form of a plain text, for example, Post Office Protocol Version 3 (POP3), Hypertext Transfer Protocol (HTTP), File Transfer Protocol (FTP), or TELNET. In this embodiment, the mailer 24 conducts transmission and reception of an electronic mail by using POP3 protocol. The browser 25 uses HTTP or FTP.

The virtual NIC 7B is a virtual network interface card for communicating with the server 100 via the management virtual machine 6A, and is a program executed by the CPU.

The management virtual machine 6A includes a physical NIC driver 7A, a service operating system (OS) 8A, a management application (APP) 9A, and the like.

The physical NIC driver 7A is a program for controlling an NIC 11 for performing communication with the server 100.

The service OS 8A is an operating system for executing an application such as the management APP 9A and the like. The service OS 8A limits access from a guest OS 8B and a client software 9B in another user virtual machine 6B to resources such as the file 110 in the management virtual machine 6A and prohibits change of data within the management virtual machine 6A.

The management APP 9A includes a protocol analysis section 21 and a protocol conversion section 22. The protocol analysis section 21 analyzes contents of packet data transmitted from the user virtual machine 6B or a sever software in the server 100 to detect a destination address and a protocol of the packet data.

The protocol conversion section 22 converts the detected protocol to a protocol to be transmitted to the server 100 when the destination address is the server 100. For example, when a protocol of a packet transmitted from the user virtual machine 6B is POP3, the protocol conversion section 22 converts the protocol to Authenticated Post Office Protocol (APOP) to transmit the same to the server 100. In contrast, when a protocol of a packet transmitted from the server 100 is APOP, the protocol conversion section 22 converts the protocol to POP3 protocol to transmit the same to the user virtual machine 6B.

When a protocol of a packet transmitted from the user virtual machine 6B is FTP, the protocol conversion section 22 converts the protocol to File Transfer Protocol over Transport Layer Security (TLS)/Secure Sockets Layer (SSL) (FTPS) to transmit the same to the server 100. In contrast, when a protocol of a packet transmitted from the server 100 is FTPS, the protocol conversion section 22 converts the protocol to FTP to transmit the same to the user virtual machine 6B.

When a protocol of a packet transmitted from the user virtual machine 6B is TELNET, the protocol conversion section 22 converts the protocol to TELNETS (telnet protocol over TLS/SSL) to transmit the same to the server 100. In contrast, when a protocol of a packet transmitted from the server 100 is TELNETS, the protocol conversion section 22 converts the protocol to Telnet to transmit the same to the user virtual machine 6B.

Incidentally, APOP is a protocol which has encrypted information such as a user name or a password relating to an authentication processing of POP3. POP3S is a protocol which has implemented Secure Sockets Layer (SSL) or Transport Layer Security (TLS) on a transport layer of POP3. HTTPS is a protocol which has implemented SSL or TLS on a transport layer of HTTP. FTPS is a protocol which has implemented SSL or TLS on a transport layer of FTP. TELNETS is a protocol which has implemented SSL or TLS on a transport layer of TELNET.

Next, the mailer 24 is explained as an example. The management virtual machine 6A receives packet data of POP3 from the mailer (POP3 client) 24 operating on the user OS 8.

The protocol analysis section 21 analyzes header information of the received packet to detect the kind of a protocol of the received packet. In this case, the protocol analysis section 21 detects that the protocol of the received packet is POP3.

The protocol conversion section 22 converts the received packet of POP3 protocol to a packet of APOP protocol to transmit the same to the server 100. Upon receipt of a packet including a plain text authentication information (account information, password) from the mailer 24 on the guest OS 8B, the management virtual machine 6A encrypts the same to transmit it to the server 100.

By adopting such a configuration, the authentication information which is a plain text can be prevented from flowing in a network in the POP3 protocol. Conventionally, such a case occurs frequently that a general user cannot discriminate APOP and POP3 from each other so that he/she cannot understand how to actuate APOP without actuating POP3. In this connection, according to the present system, even if a mail client utilized by a user has been set such that use of APOP is invalid, encryption is performed and authentication with a destination server on a network can be achieved securely.

Incidentally, since only a portion corresponding to the authentication is encrypted in APOP, a header and a main text of a mail remain as plain text. Therefore, the plain text may be peeped by anyone else. Therefore, data flowing in a network may be encrypted by using POP3S (POP3 over TLS/SSL) utilizing SSL or the like in order to prevent contents from leaking.

Similarly, FTP or Telnet are mutually converted to FTPS or TELNETS so that secure data communication can be realized.

Incidentally, in the abovementioned example, when the APOP, POP3S, HTTPS, TELNETS, and FTPS servers is not running on the side of the server 100 (a communication port is closed), a protocol unrelated to the application layer may be used. For example, a protocol for performing encryption for each Internet Protocol (IP) packet such as SSL (TLS) or IPsec (Security Architecture for Internet Protocol) is used in a transport layer.

A secure communication path based upon VLAN using a Layer 3 switch is established so that data such as POP3, FTP, or Telnet may be transmitted on the communication path.

For example, upon reception of a packet of connection request of FTP from the FTP client on the guest OS 8B, the management virtual machine 6A establishes a secure communication path between the same and a destination server 100 using SSL protocol and encrypts data between the FTP client and the destination server to relay the same by using the established secure communication path, so that secure data communication can be realized. The TELNET protocol is also similar to the above.

By adopting the above configuration, authentication information of the POP3, FTP, and TELNET protocols or the like is encrypted to be caused to flow on a network even if a user has no intention. Since information such as authentication processing information is not present on the hybrid PC client 2B, it is prevented from being accidentally erased by a user or being hacked.

When a regular employee is designated as a manager of the user virtual machine 6B and an IT device manager is designated as a manager of the management virtual machine 6A, management and setting of the virtual server section (service OS) can be performed by an acquainted manager so that such a merit can be obtained that higher security measures can be implemented.

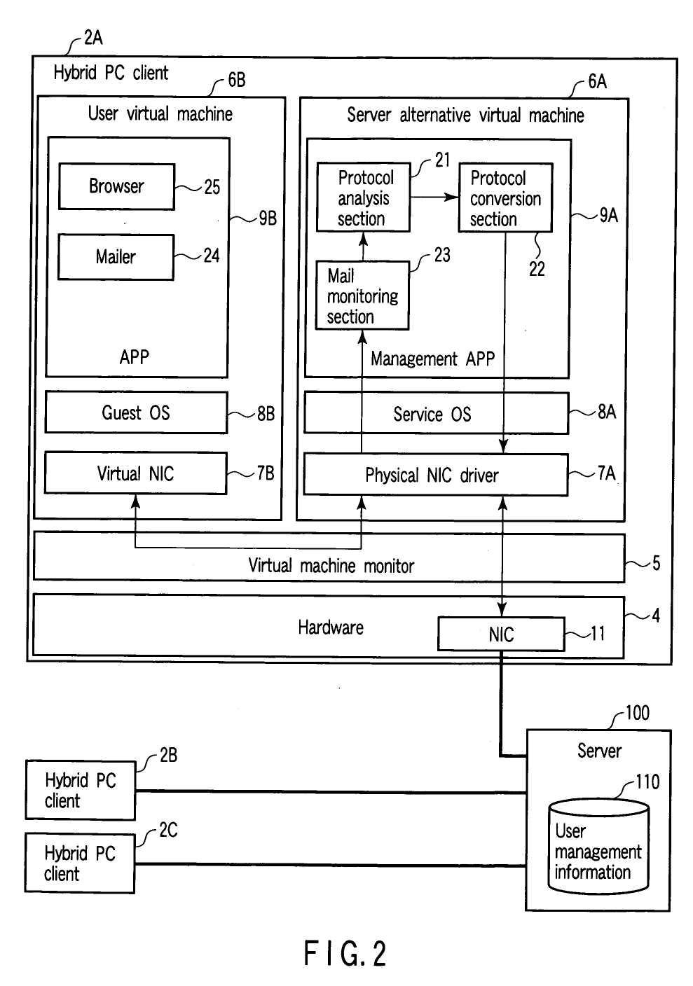

FIG. 2 shows a modification example of the present embodiment. In transmission and reception of electronic mails, a packet such as POP3 is encrypted to be flowed on a network, so that a conventional mail monitoring device or the like cannot be used. As shown in FIG. 2, however, by adding a mail monitoring section 23 which checks contents of mail before the mail is encrypted in the protocol conversion section 22 and contents of the mail after the mail is decoded, the contents of the mail can be monitored at an individual PC and it can be left therein.

### Second Embodiment

In the example shown in FIG. 1, the example where the management virtual machine 6A encrypts packets of POP3, FTP, and TELNET to relay them to destination servers has been shown. An example where a reproduction of a file such as user management information such as an user name or a password or data of electronic mail contained in the server 100 is prepared in the management virtual machine 6A via a secure communication path instead of relaying a packet of POP3, FTP, or TELNET and a processing such as authentication is performed by a virtual server machine will be explained below.

FIG. 3 is a block diagram showing a schematic configuration of information processing system according to a second embodiment of the present invention.

As shown in FIG. 3, a server 100 includes a user management information/various data file 110 and a server software 120.

A hybrid PC client 2A includes a server alternative virtual machine 6A, a user virtual machine 6B, and the like. The server alternative virtual machine 6A includes a physical NIC driver 7A, a service OS 8A, an application 9A, user management information/various data files (hereinafter, called a “reproduction file”) 111, and the like. The application 9A includes a virtual server application 30. The virtual server application 30 includes a protocol analysis section 31, an FTP client 32, virtual server software 33, and the like.

The user virtual machine 6B includes a virtual NIC 7B, a guest OS 8B, a client software 9B, and the like. A user application includes client software such as a mailer 24, a browser 25, and the like.

The user management information/various data file (hereinafter, called a “file”) 110 is a file for user management information such as a user name or a password, or data of electronic mail. The server software 120 performs communication with applications in the guest OS 8B or the client software 9B in the user virtual machine 6B using the user management information/various data file 110 to conduct a predetermined processing. For example, the server software 120 includes an FTP server 121, a mail server, a HTTP server, and the like.

The FTP server 121 provided in the server 100 transfers a file such as user management information such as an user name or a password or data of electronic mail by the FTP protocol using the FTP client 32 in the management virtual machine 6A to prepare a reproduction file 111 of the file 110 in the management virtual machine 6A.

Incidentally, transfer of the file 110 to the server alternative virtual machine 6A from the server 100 uses a protocol which can encrypt data regardless of a protocol such as an application layer. External peeping can be restricted by VLAN using a Layer 3 switch.

Preparation of reproduction of a file to the server alternative virtual machine 6A can be performed periodically from the server 100 or as necessary.

When packet data is transmitted from the user virtual machine 6B, the packet data is hooked by the protocol analysis section 31. The protocol analysis section 31 analyzes packet data transmitted from the user virtual machine 6B to the outside to detect a destination address, a communication port and a protocol. When the detected destination address is the server 100 and a port corresponding to the server software 120, the protocol analysis section 31 transmits the packet data to the virtual server software 33 corresponding to the detected port.

The virtual server software 33 performs a predetermined processing such as authentication processing with the guest OS 8B or the client software 9B in the user virtual machine 6B or transmission and reception of electronic mail data using the reproduction file 110.

Incidentally, by sharing not only the file 110 on the hard disk of the server 100 but also memory information in the server 100, transmission from the server 100 to the server alternative virtual machine 6A may be conducted by secure communication means in real time. By adopting such a configuration, a clone of the server 100 can be executed by the server alternative virtual machine 6A, so that a processing in lieu of the server 100 can be realized by the server alternative virtual machine 6A in real time.

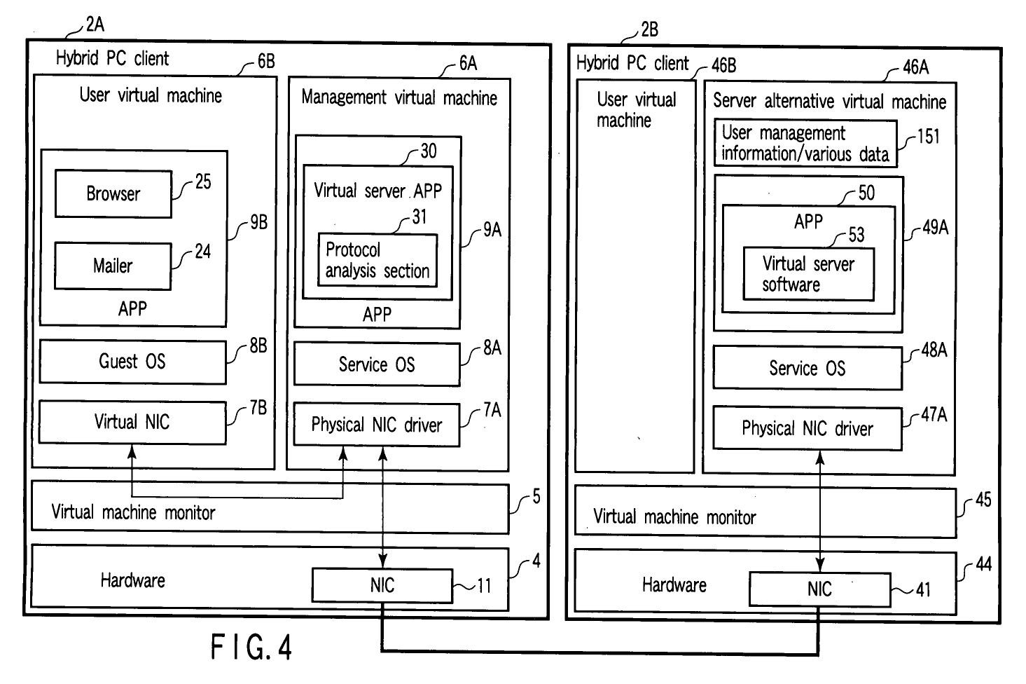

As shown in FIG. 4, utilizing a server alternative virtual machine 46B in another hybrid PC client 2B instead of the server 100, a predetermined processing may be performed between the hybrid PC client 2A and the hybrid PC client 2B.

By adopting such a configuration, when the server 100 does not put APOP, POP3S, FTPS, or TELNETS in active state or the communication port is closed, authentication information of plain text can be prevented from flowing in a network like the above.

Since the reproduction file 111 including information relating to the authentication processing resides in the server alternative virtual machine 6A which cannot be accessed from the user virtual machine 6B, it is prevented from be accidentally erased by a user or being hacked.

In the example explained in the first embodiment, correlativity is high such that a user operation such as start of mail operation or file access conducted by a user and traffic transmitted from a personal computer are approximately linked to (proportional to) each other, but the correlatively is relatively low in the example shown in the second embodiment so that activity of a user can be prevented from being estimated from the traffic.

Incidentally, the hybrid PC client 2B is provided with hardware 44, an NIC 41, a virtual machine monitor 45, a server alternative virtual machine 46A, a physical NIC driver 47A, a service OS 48A, an application 9A, a virtual server application 50, a protocol analysis section, an FTP client, a virtual server software 53, a user management information/various data 131, a user virtual machine 46B, and the like as well as the hybrid PC client 2A.

As explained above, as vulnerability measures of POP3, FTP, and TELNET, such a new protocol as FTPS or TELNETS combined with Authenticated Post Office Protocol (APOP) obtained by adding a function of encrypting a password to POP3 or Secure Sockets Layer (SSL) is already present, but it is currently required that a user understands the vulnerability of POP3, FTP, or TELNET as first explained in order to improve security using the new protocols. For example, the APOP protocol is not available in an initial setting (default) state in much mail software. A user must change an option such as “to utilize APOP server” from invalidation to availableness. However, necessity of such a change cannot be enforced fully at present.

Account information or password information of plain text such as POP3, FTP, or TELNET can be prevented from directly flowing in a network regardless of setting of software conducted by a user. That is, a system with improved security can be provided without making a user aware of security.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. Information processing apparatus where a first software including a first operating system and a first program group running on the first operating system, and a second software including a second operating system and a second program group running on the second operating system run concurrently, comprising:
a client software which belongs to the first program group, and transmits and receives a server software executed by a server connected via a network and data according to a first protocol for performing communication for performing a processing including authentication processing;
an access preventing section configure to prevent accessing from the first software to a resource in the second software; and
a flowing preventing section configure to prevent information of a plain text regarding the authentication processing from being flowed in the network.

2. The information processing apparatus according to claim 1, wherein
the flowing preventing section comprises
analysis section which belongs to the second program group, and configure to analyze data transmitted from the client software to the server and data transmitted from the server to the client software, and
relaying section which belongs to the second program group, and configure to relay communication between the client software and the server according to analyzed result of the analysis section, the relaying section converts data of the first protocol transmitted by the client software to data of a second protocol where information relating to at least the authentication processing is encrypted to transmit the same to the server and converts data of the second protocol transmitted by the server to data of the first protocol to transmit the same to the client software.

3. The information processing apparatus according to claim 2, wherein
the second protocol is a protocol implemented with a protocol for encrypting data in a transport layer.

4. The information processing apparatus according to claim 3, wherein
the second protocol is a protocol implemented with at least one of Secure Sockets Layer (SSL) and Transport Layer Security (TLS) in the transport layer.

5. The information processing apparatus according to claim 2, wherein
the second protocol is a protocol which performs encryption for each Internet Protocol (IP) packet.

6. The information processing apparatus according to claim 2, wherein
the client software is a mail client which conducts transmission and reception of electronic mail, and
the mail client includes monitoring section configure to monitor data of electronic mail transmitted/received between the relaying section and the mail client.

7. The information processing apparatus according to claim 1, wherein
the server includes data resource containing information relating to the authentication processing, and preparing section configure to prepare reproduction of the data resource in the second software, and
the information processing apparatus further comprises
a storage device,
agent section which belongs to the second program group, and configure to act for a processing of the predetermined processing performed by the server using reproduction of the data resource, and
communication section configure to perform communication with the server using a second protocol for keeping confidential communication between the information processing apparatus and the sever from the outside in order to store the reproduction of the data resource in the storage device.

8. The information processing apparatus according to claim 7, wherein
the second protocol is a protocol which has a function for encrypting data in a transport layer.

9. The information processing apparatus according to claim 8, wherein
the second protocol is a protocol which performs encryption for each Internet Protocol (IP) packet.

10. Information processing system comprising:
a server which is connected to a network and includes data resource containing information relating to an authentication processing and a server software for conducting a processing using the data resource;
information processing apparatus where a first software including a first operating system and a first program group running on the first operating system, and a second software including a second operating system and a second program group running on the second operating system run concurrently, the information processing apparatus comprising environment preventing section configure to prevent change of an environment within the second software performed from the first software, and a client software which belongs to the first program group and transmits and receives the server software and data according to a first protocol for performing communication for performing a processing including authentication processing; and
a following preventing section configure to prevent information of a plain text regarding the authentication processing from being flowed in the network.

11. The information processing system according to claim 10, wherein
the following preventing section comprises
analysis section which belongs to the second program group, and configure to analyze data transmitted from the client software to the server and data transmitted from the server to the client software, and
relaying section which belongs to the second program group, and configure to relay communication between the client software and the server according to analyzed result of the analysis section, and the relaying section converts data of the first protocol transmitted by the client software to data of a second protocol where information relating to at least the authentication processing is encrypted to transmit the same to the server and converts data of the second protocol transmitted by the server to data of the first protocol to transmit the same to the client software.

12. The information processing system according to claim 11, wherein
the second protocol is a protocol implemented with a protocol for encrypting data in a transport layer.

13. The information processing system according to claim 12, wherein
the second protocol is a protocol implemented with at least one of Secure Sockets Layer (SSL) and Transport Layer Security (TLS) in the transport layer.

14. The information processing system according to claim 11, wherein
the second protocol is a protocol which performs encryption for each Internet Protocol (IP) packet.

15. The information processing system according to claim 11, wherein
the client software is a mail client which conducts transmission and reception of electronic mail, and
monitoring section configure to monitor data of electronic mail transmitted/received between the relaying section and the mail client is further provided.

16. The information processing system according to claim 11, wherein
the server includes reproduction section for preparing reproduction of the data resource in the second software, and
the information processing apparatus further comprises
a storage device,
agent section which belongs to the second program group, and configure to act for a processing of the predetermined processing performed by the server using reproduction of the data resource, and
a confidence section configure to perform communication with the server using a second protocol for keeping confidential communication between the information processing apparatus and the sever from the outside in order to store the reproduction of the data resource in the storage device.

17. The information processing system according to claim 16, wherein
the second protocol is a protocol which has a function for encrypting data in a transport layer.

18. The information processing system according to claim 16, wherein
the second protocol is a protocol which performs encryption for each Internet Protocol (IP) packet.

19. The information processing system according to claim 16, wherein
the confidence section is a virtual local area network (VLAN).

20. The information processing system according to claim 16, further comprising:
another information processing apparatus where a third software including a third operating system and a third program group running on the third operating system, and a fourth software including a fourth operating system and a fourth program group running on the fourth operating system run concurrently, and the another information processing apparatus including another client software which belongs to the third program group and performs a predetermined processing using the data resource between the client software and the server, wherein
the information processing apparatus further comprises agent section which belongs to the second program group, and configure to act for a processing executed by the server of processes executed between the another client software and the server using reproduction of the data resource stored in the storage device.
